(19) United States
(12) Patent Application Publication
(10) Pub. No.: US 2008/0157916 A1
(43) Pub. Date: Jul. 3, 2008

(54) Thermostatic Element, in Particular, for a Cooling Circuit and a Method for the Production Thereof

(75) Inventor: Rene Mas, Bretigny Sur Orge (FR)

Correspondence Address: Ralph A. Dowell of DOWELL & DOWELL P.C., 2111 Eisenhower Ave, Suite 406, Alexandria, VA, 22314, US

(73) Assignee: Vernet, Ollainville (FR)

(21) Appl. No.: 11/887,076

(22) PCT Filed: Apr. 3, 2006
(86) PCT No.: PCT/FR2006/000728

§ 371 Date: Sep. 25, 2007

(30) Foreign Application Priority Data
Apr. 4, 2005 (FR) 05 03296

(51) Int. Cl. H01H 37/04; H01H 11/00

(52) U.S. Cl. 337/380; 29/622

(57) ABSTRACT

A thermostatic element (1) comprises a thermoconductive cup (2) containing a thermo-expandable substance (3) and a piston (4), which is axially displaceable with respect to said cup by the action of the thermo-expandable substance produced during the expansion thereof. The guiding of the piston with respect to the cup and the sealing of the thermo-expandable substance are provided by the same arrangement of a single-piece holder (5) comprising a rigid insert (51) for guiding the piston which is embedded into a flexible envelop (52) impermeable to said thermo-expandable substance and is interposed between the insert, the piston and the cup. In order to provide a reliable sealing between the insert and the cup, including the case of assembling on an automatic line, the insert is provided with an abutment (51) which positions the single piece holder and projectingly extends towards the thermo-expandable substance away from the substantially flat part (51A) of the rest of the insert in a direction which is substantially parallel to the piston axis (X-X) and a space limited on the insert side oriented towards the thermo-expandable substance between the abutment and the flat part of the insert is filled with a corresponding part (52D) of the envelop which is pressed against the cup in a sealing manner.

The present invention relates to a thermostatic element which, by using a heat-expandable material, converts a calorific energy into a mechanical energy. It also relates to a method for manufacturing such an element.

These elements are routinely used in the field of fluid regulation since they make it possible to distribute a fluidic supply channel into one or more distribution channels, according to the heat of the fluid to be regulated and/or of another heat source. These elements are therefore arranged in cooling circuits in which a cooling fluid flows, particularly the cooling circuits associated with an internal combustion engine of a motor vehicle or similar element.

Typically, a thermostatic element comprises a metal cup of generally cylindrical shape and containing a heat-expandable material such as a wax. The element also comprises a piston substantially coaxial with the cup and able to be moved in translation relative to this cup under the effect of the expansion of the heat-expandable material contained in the cup, when this material is heated. By expanding, the heat-expandable material partially expels the piston, so that the latter is deployed outside the cup while, when the heat-expandable material cools, the piston may be retracted into the cup, usually under the action of a return spring associated with the thermostatic element. To guide the movements in translation of the piston, the thermostatic element comprises a bored metal guide inside which the piston slides, this guide being firmly attached to the cup. In addition, to prevent the heat-expandable material from escaping from the cup during the movements of the piston, this material is sealed relative to the outside, the sealing means used often being provided to transmit to the piston the thrust of the heated material.

Conventionally, the sealing of the heat-expandable material is provided by a composite structure interposed between the expandable material and the end of the piston plunging into the cup. This structure usually comprises a flexible diaphragm for the retention of the wax, firmly immobilized on the guide, a deformable pad housed in the bore of the guide and in contact with the surface of the diaphragm opposed to the weight of the wax, and a shim inserted between the pad and the piston in a manner adjusted to prevent the material forming the pad from creeping around the piston. This “sandwich” design is well suited to the use of a highly expandable wax for causing an ample movement of the piston.

However, this composite sealing structure is tricky to assemble since each of its constituent parts must be handled in turn, put in place and, where necessary, immobilized within the thermostatic element. These handling operations are all the more complex because these parts have small dimensions, which increases, on the one hand, the time for assembling the thermostatic elements and, on the other hand, the cost of the assembly lines whose robots have to be precise. The result of this is that the unit price of the thermostatic elements is relatively high if elements with good reliability are desired.

Through U.S. Pat. No. 3,080,756, U.S. Pat. No. 3,712,053 and FR-A-1 232 776, thermostatic elements are known in which the heat-expandable wax is sealed by a one-piece composite assembly including a metal insert to guide the piston of the thermostatic element, sunk into a flexible and sealed casing. In U.S. Pat. No. 3,080,756 and U.S. Pat. No. 3,712,053, this casing is interposed between the insert and, on the one hand, the piston and, on the other hand, the cup of the thermostatic element, while, in FR-A-1 232 776, a woven sheath covers most of the piston of the thermostatic element, which makes the latter difficult to assemble, particularly on an automated assembly line. In any case, the inserts of these one-piece assemblies have, on the side of the wax, a totally flat face, between which and a portion facing the collar a matching portion of casing is provided. This portion of casing is critical from the point of view of the sealing of the wax because, in service, the high pressure that exists inside the cup tends to damage its seal. In practice, the dimensioning and the production of this portion of casing are decisive from the point of view of the seal of the thermostatic elements envisaged in the aforementioned three documents, so that the assembly of these elements along automated lines is incompatible with a high level of reliability.

The object of the present invention is to propose a novel thermostatic element which, while being as reliable as the existing elements, is easier, quicker and less costly to manufacture, particularly with automatic assembly lines.

Accordingly, the subject of the invention is a thermostatic element comprising:
a heat-conductive cup containing a heat-expandable material,
a piston that can be moved along an axis relative to the cup under the action of the heat-expandable material when this material expands,
a one-piece assembly comprising a rigid insert for guiding the piston relative to the cup, sunk into a flexible casing sealed against the heat-expandable material and interposed between the insert and, on the one hand, the piston and, on the other hand, the cup, characterized in that the insert includes an abutment for positioning the one-piece assembly relative to the cup, which abutment extends in protrusion toward the heat-expandable material from a substantially flat portion of the rest of the insert in a direction substantially parallel to the axis of movement of the piston, the space delimited, on the side of the insert facing the heat-expandable material, between the abutment and the flat portion of the insert being at least partly filled with a corresponding portion of filler of the casing, squashed with sealed pressure against a corresponding bearing portion of the cup.

The use of a one-piece assembly as aforementioned, which ensures both the guidance of the piston relative to the cup and the sealing of the heat-expandable material relative to the outside of the thermostatic element, prevents the use and handling of the various corresponding parts of the existing thermostatic elements, such as the guide, the diaphragm, the pad and the shim mentioned above. On an automatic assembly line, the installation of this one-piece assembly represents only one operation. In addition, unlike the aforementioned various small dimension parts, this assembly has a relatively large overall dimension, which makes it easier to handle by robots or similar programmable controllers, whose operating constraints are less than those associated with high precision programmable controllers. The result of this is that the thermostatic element according to the invention has a lower manufacturing cost than the existing elements.

In addition, the presence of the protruding abutment makes it possible, during the assembly of the thermostatic element according to the invention, to rigorously control both the positioning of the one-piece assembly relative to the cup and the squashing of the portion of filler: since this portion of filler occupies the angled space delimited by the abutment, the user controls the degree of squashing of this portion of filler when the abutment is positioned and brought to bear against the corresponding bearing portion of the cup, this pressing action being easily carried out by a robot or a programmable controller along an automated assembly line. By ensuring in this way a minimal degree of squashing of this portion of filler, the user ensures a predetermined level of seal in a zone of the casing subjected to significant internal pressure stresses. The angled shape of the protruding abutment advantageously makes it possible to absorb a portion of this internal pressure.

In addition, the rigid insert may advantageously withstand the mechanical stresses resulting from swaging together the cup and the insert during the manufacture of the thermostatic element according to the invention.

Other features of this thermostatic element, taken in isolation or in all the technically possible combinations, are set out in dependent claims 2 to 15.

A further subject of the invention is a method for manufacturing a thermostatic element in which are provided:
a heat-conductive cup partly filled with a heat-expandable material,
a piston; and
a rigid insert for guiding the piston,
   in which the piston is partly fitted inside the cup, so that this piston can be moved along an axis relative to the cup under the action of the heat-expandable material when this material expands,
   in which the insert is sunk into a flexible casing sealed against the heat-expandable material and suitable for being interposed between the insert and, on the one hand, the piston and, on the other hand, the cup, the insert and the casing forming a one-piece assembly, and
   in which the one-piece assembly is fitted into the cup so that a portion of the casing is interposed between the insert and the cup while another portion of the casing is interposed between the insert and the piston when the latter is assembled,
   characterized in that, when the one-piece assembly is placed in the cup, this assembly is positioned relative to the cup by using an abutment of the insert, which extends in protrusion toward the heat-expandable material from a substantially flat portion of the rest of the insert in a direction substantially parallel to the axis of movement of the piston, the space delimited, on the side of the insert facing the heat-expandable material, between the abutment and the flat portion of the insert being at least partly filled with a corresponding portion of filler of the casing,
   and in that, after the one-piece assembly has been placed in the cup, this portion of filler is squashed axially with sealed pressure against a corresponding bearing portion of the cup, by swaging the abutment and the cup together.

The invention will be better understood on reading the following description, given solely as an example and made with reference to the drawings in which:

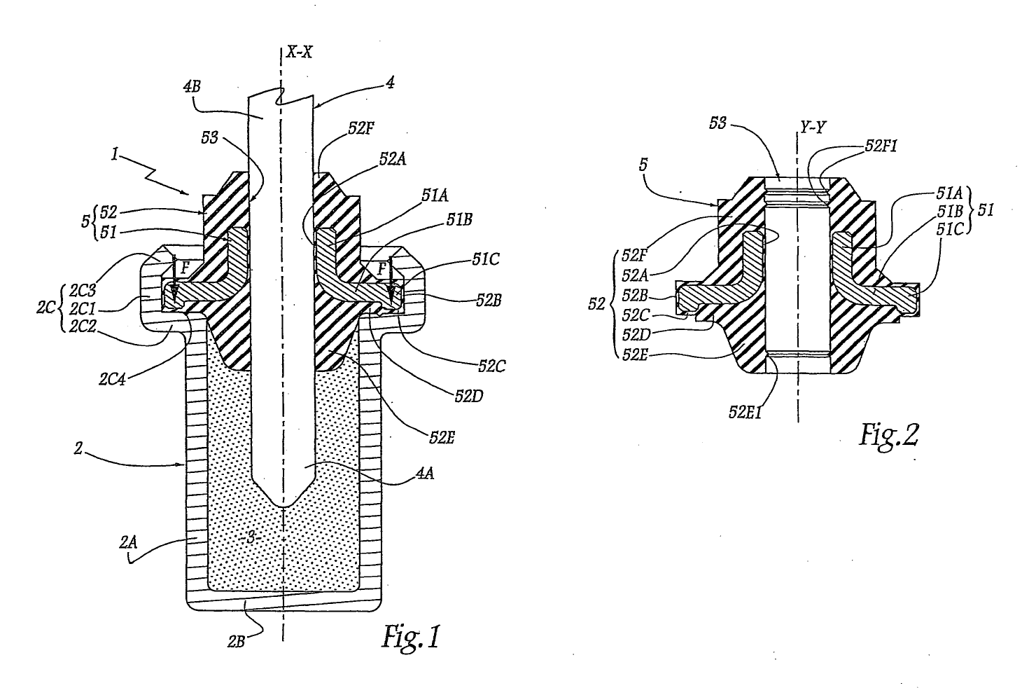

FIG. 1 is a longitudinal section of a thermostatic element according to the invention;

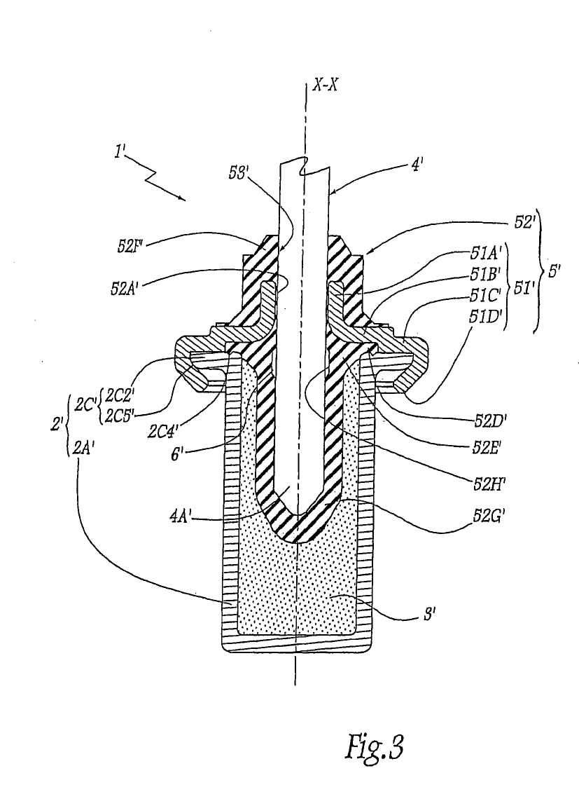

FIG. 2 is a view, similar to FIG. 1, of a portion of the thermostatic element, in the unassembled state; and

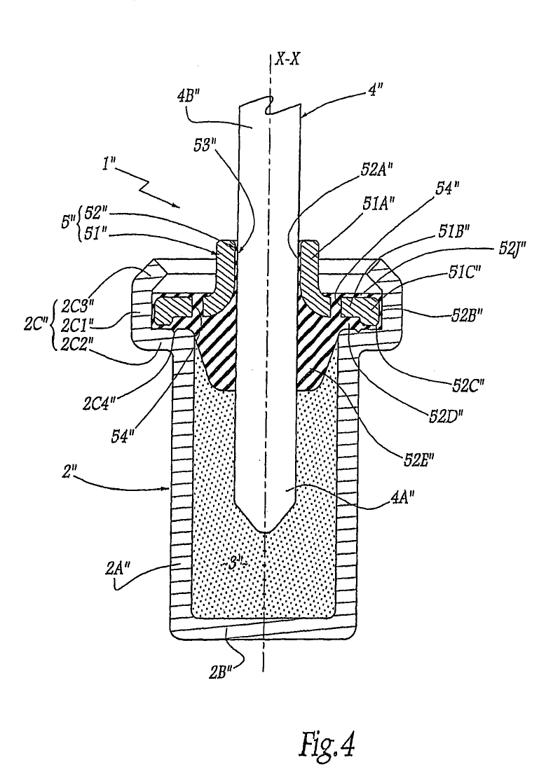

FIGS. 3 and 4 are views, similar to FIG. 1, of two other embodiments of the thermostatic element according to the invention.

FIG. 1 represents a thermostatic element 1 comprising:
a metal cup 2 of generally cylindrical shape with a circular base and with a longitudinal axis X-X,
heat-expandable wax 3 stored in the cup 2 and where necessary filled with a powder having a good heat conductivity, for example a copper powder,
a metal piston 4 generally cylindrical and substantially coaxial with the cup 2, of which an end portion 4A plunges into the wax 3 while its opposite end portion 4B is only partially shown; this piston can be moved in translation along the axis X-X relative to the cup under the action of the wax when the latter expands, and
a one-piece assembly 5 suitable for both guiding the piston 4 in translation relative to the cup 2 and sealing the wax 3 against the outside of the thermostatic element 1.

For convenience, the rest of the description will be oriented by considering that the terms “lower” and “down” indicate a direction directed toward the bottom portion of FIGS. 1 and 2, while the terms “top” and “up” indicate an opposite direction. The same applies with respect to FIG. 3.

The cup 2 comprises a tubular barrel 2A centered on the axis X-X which, at its bottom end, is closed off by a bottom wall 2B, while at its top end, the barrel is open to the outside while forming an end collar 2C. The wax 3 is stored in the closed bottom portion of the barrel 2A, the top portion of the barrel being closed off by the end portion 4A of the piston 4 and by the assembly 5. The collar 2C is made up of an annular body 2C1 centered on the axis X-X which, in the bottom portion, is made of the same material as and in one piece with the barrel 2A while forming a shoulder 2C2 and which, in the top portion, is folded upward in a convergent manner toward the axis X-X, forming an inclined end edge 2C3.

The assembly 5 essentially comprises a rigid insert 51, particularly metallic, and a flexible casing 52, made in a single piece that totally shrouds the insert 51. This casing 52 is made of a material that is sealed against wax 3, for example rubber, nitrile, hydrogenated nitrile or a mixture of these materials. In FIG. 1, the assembly 5 is assembled to the rest of the thermostatic element 1 while in FIG. 2 this assembly is freestanding, that is to say that the assembly is ready to be assembled to the rest of the components of the thermostatic element.

The insert 51 and the casing 52 have respective shapes of revolution about a longitudinal axis Y-Y indistinguishable from the axis X-X in FIG. 1. Globally, the assembly 5 internally delimits a substantially cylindrical through-passageway 53, centered on the axis Y-Y and capable of receiving, in a sliding and sealed manner, the piston 4, as in FIG. 1.

More precisely, the insert 51 comprises, as it gets further away from the axis Y-Y, a top ring 51A coaxial with the axis Y-Y, an intermediate flange 51B that is substantially flat and that extends in a plane substantially perpendicular to the axis Y-Y, and an annular bottom edge 51C coaxial with the axis Y-Y. This edge 51C therefore extends in protrusion downward from the periphery of the flange 51B, in a direction substantially parallel to the axis. The ring, the flange and the edge form one and the same part, centered on the axis Y-Y. The ring 51A has a slightly larger internal diameter than the external diameter of the piston 4 so that, in the assembled state of the element 1, the piston is received inside the ring with interposition of a corresponding portion 52A of the casing 52 which covers the ring internally. In the assembled state of the element 1, the flange 51B extends, as it gets further away from the axis X-X, almost to the annular body 2C1 of the collar 2C, so that the external portion of the bottom face of this flange extends substantially parallel to the internal portion of the top face of the shoulder 2C2 of the collar. The edge 51C has a slightly smaller external diameter than the internal diameter of the annular body 2C1, so that the insert 51 is centered inside the collar 2C with radial interposition of a corresponding portion 52B of the flexible casing 52. Similarly, a portion 52C of the casing 52 is axially interposed between the edge 51C of the insert 51 and the external portion of the top face of the shoulder 2C2 of the collar 2C.

The bottom space delimited between the edge 51C and the flange 51B is filled with a portion 52D of the casing 52. In the free state of the assembly 5, this portion of casing 52D extends in protrusion downward relative to the adjacent portion of casing 52C, as shown in FIG. 2, while, in the assembled state of the element 1, these two portions of casing 52C and 52D are flush with one another, pressed against the top face of the shoulder 2C2 of the collar 2C. In practice, the portion of casing 52D is axially squashed against the shoulder 2C2 when the assembly 5 is assembled, this squashing, typically of the order of 40%, being dimensioned in order to ensure a reliable seal between the casing 52 and the cup 2.

Advantageously, in the squashed zone of the portion of casing 52D, the top face of the shoulder 2C2 is hollowed out with an annular groove 2C4 centered on the axis X-X and filled with the portion of casing 52D when the assembly 5 is assembled, in order to improve the seal.

On either side, along the axis Y-Y, of the insert 51, the casing 52 forms a bottom protrusion 52E and a top protrusion 52F. These protrusions 52E, 52F extend in the extension of the portion of casing 52A, respectively downward and upward, so that the wall delimiting the passageway 53 is made up entirely of the material of the casing 52, this passageway being delimited in turn by, from bottom to top, the protrusion 52E, the portion of casing 52A and the top protrusion 52F. When the piston 4 is received in this passageway 53, the bottom protrusion 52E seals the wax 3 relative to the piston 4, the pressure existing in the wax being able to reach 200 bar, while the top protrusion 52F seals the piston relative to the outside of the thermostatic element, particularly relative to a fluid in which the thermostatic element 1 can be bathed, in particular when the temperature of this fluid is relatively low, which makes it easier to insert fluid between the piston and the wall of the passageway 53.

In order to reinforce their seal, the protrusions 52E and 52F are furnished with respective annular ribs 52E1, 52F1, which extend in protrusion from the rest of the wall delimiting the passageway 53, toward the axis Y-Y.

The thermostatic element 1 is manufactured as follows.

First, the assembly 5 is manufactured independently of the other components of the thermostatic element 1. To do this, the insert 51 is preferably obtained by stamping a metal sheet. As variants, the insert is formed by machining or drop-forging. The insert 51 is then sunk into the casing 52, particularly by using a mold which confers on the casing 52 its contours in the free state as shown in FIG. 2. The mold used is particularly designed to produce the ribs 52E1 and 52F1, the protrusions 52E and 52F and the various portions of casing 52A to 52D around the insert 51.

Secondly, after the cup 2 has been filled with wax 3, the assembly 5 is assembled to the cup 2, the installation of this assembly being easily obtained by the interaction of shapes between the edge 51C of the insert 51 and the annular body 2C1 of the collar 2C. It can therefore be understood that the edge 51C forms a positioning abutment of the assembly 5 relative to the cup 2 and ensures that the assembly 5 is centered on the cup 2 while making the axes X-X and Y-Y substantially indistinguishable.

The assembly 5 is installed while the top edge 2C3 of the annular body 2C1 is not bent as in FIG. 1. On the other hand, once this installation has been carried out, the top end of this body 2C1 is bent to its configuration of FIG. 1, while being swaged around the edge 51C of the insert 51 which therefore effectively withstands the mechanical forces and the stresses associated with the swaging.

During the swaging, the portion of casing 52D is axially squashed against the shoulder 2C2 of the collar 2C, as indicated by the arrow F, until it takes the configuration of FIG. 1. It can be understood that this swaging leads to axially constraining the edge 51C in the direction of the shoulder 2C2, which squashes the portion of casing 52D, until the edge butts axially against this shoulder, with the portions of casing 52C and 52D axially interposed. The axial abutment of the edge 51C against the shoulder 2C2 is strong because the latter is flat and extends perpendicularly to the axis X-X. In this manner, the degree of squashing of the portion of casing 52D is easily and effectively controlled, including along an automated assembly line.

The wax 3 is therefore reliably and repetitively sealed.

The piston 4 is then inserted into the passageway 53 of the assembly 5 already positioned on the cup 2, until its end portion 4A is immersed in the wax 3.

FIGS. 3 and 4 respectively represent two thermostatic elements 1′ and 1″, variants of the thermostatic element 1 of FIG. 1. These thermostatic elements 1′ and 1″ comprise many components identical to those of the element 1, these components bearing the same alphanumeric reference numbers as those of FIGS. 1 and 2, respectively followed by a prime (′) and a double point (″).

The element 1′ of FIG. 3 differs from the element 1 on the one hand at the bottom zone of the casing 52′ and, on the other hand, at the zone of swaged junction between its insert 51′ and its cup 2′.

With respect to the bottom zone of the casing 52′, the variant of FIG. 3 consists, relative to the element 1 of FIGS. 1 and 2, in extending the flexible casing 52′ downward, beyond the bottom protrusion 52E′, so that the casing extends all around and beneath the bottom end portion 4A′ of the piston 4′. This extension of material therefore forms a blind glove finger 52G′ and is similar to a structure commonly called a “squeeze push” in the field of thermostatic elements. The glove finger 52G′ closes off the passageway 53′ at its bottom end and receives the bottom end portion 4A′ of the piston 4′, while being interposed between the piston and the wax 3′.

The addition of the glove finger 52G′ in the variant of FIG. 3 ensures that the element 1′ operates better at high pressure.

In addition, optionally, the grease 6′ designed to make the piston 4′ slide more easily in the passageway 53′ may then be stored in an annular recess 52H′ hollowed out in the wall of the casing 52′ delimiting the passageway 53′, beneath the level of the insert 51′.

With respect to the zone of junction between the insert 51′ and the cup 2′, unlike the collar 2C of the cup 2 of the element 1, the collar 2C′ does not extend the barrel 2A′ of the cup 2′ upward via an annular body such as the body 2C1 of the collar 2C, but consists only of a shoulder 2C2′ similar to the shoulder 2C2 of the cup 2C. The end edge 2C5′ of this shoulder 2C2′ is tapered while converging downward.

In addition, unlike the edge 51C of the insert 51 of the element 1, the edge 51C′ of the insert 51′ extends radially beyond the cup 2, as it gets further away from the axis X-X, since this insert 51′ has a downward angled shape whose internal diameter is substantially equal to the maximum external diameter of the shoulder 2C2′ of the cup 2′ and whose free end portion 51D′ is folded toward the axis X-X, against the edge 2C5′ of the shoulder 2C2′. Before the assembly 5′ is assembled to the cup 2′, this end portion 51D′ has an annular shape which extends in the axial extension of the downward angle of the edge 51C′. In this pre-assembly state (not shown), the portion of casing 52D′ is substantially dimensioned like the portion of casing 52D of the casing 52, that is to say that this portion of casing 52D′ extends in protrusion from the flange 51B′ lower than the bottom face of the edge 51C′. On the other hand, unlike the corresponding zone of the casing 52 of the thermostatic element 1, no portion of casing covers this bottom face of the edge 51C′. In other words, the casing 52′ includes no portion similar to the portions of casing 52B and 52C of the casing 52 of the element 1. On the other hand, as for the element 1 of FIGS. 1 and 2, the casing 52′ includes a portion 52A′ interposed between the insert 51′ and the piston 4′ and forms, in addition to the bottom protrusion 52E′ and the glove finger 52G′, a top protrusion 52F′.

Assembling the assembly 5′ to the cup 2′ is similar to assembling the assembly 5 to the cup 2: the assembly 5′ is fitted to the collar 2C′ of the cup 2′ by inserting the shoulder 2C2′ of this collar inside the angled edge 51C′ of the insert 51′, ensuring that the assembly 5′ is centered relative to the cup 2′; then the end portion 51D′ of the angled portion of the edge 51C′ is swaged around the shoulder 2C2′, while being guided by the rounded end edge 2C5′ of this shoulder, until it occupies the configuration inclined downward and in the direction of the axis X-X represented in FIG. 4. In the assembled state of the assembly 5′, the top face of the shoulder 2C2′ and the bottom face of the edge 51C′ are in pressing contact against one another, under the effect of the swaging of the end portion 51D′. The piston 4′ is then inserted into the passageway 53′ of the assembly 5′.

It will be noted that the arrangements of the element 1′ relative to the glove finger 52G′ and to the swaging of the insert 51′ to the cup 2C′ are independent of one another and may therefore, as a variant, be applied separately to the element 1 of FIGS. 1 and 2.

The element 1″ of FIG. 4 differs from the element 1 of FIGS. 1 and 2 essentially by the absence of the top protrusion 52F. According to this variant, the casing 52″ consists of the portions 52A″, 52B″, 52C″, 52D″ and 52E″, respectively similar to the portions of casing 52A, 52B, 52C, 52D and 52E. The volume of material forming the casing 52″ is therefore smaller and the overmolding of the insert 51″ by this casing is essentially limited to its side facing the heat-expandable wax 3″.

To ensure a sufficient mechanical hold between the casing 52″ and the insert 51″, the flat flange 51B″ is advantageously traversed axially from one side to the other by several through-holes 54″, preferably distributed in a substantially uniform manner along the periphery of this flange. These holes 54″ are for example 6 in number, two diametrically opposed holes being represented in the plane of FIG. 4. When the insert 51″ is subsequently sunk into the material designed to form the casing 52″, this material spreads into the holes 54″. On the bottom side of the flange 51B″, the casing forms, amongst other things, the portion of filler 52D″, in the angled space delimited jointly by the flange and the abutment edge 51C″, while, on the top side of the insert, the material covers the surface of the flange until it joins the lateral portion of casing 52B″ while forming only a thin coating 52J″, that is to say of a thickness similar to that of the portion of casing 52B1″. Having material on either side of the flange 51B, the casing is mechanically connected to the insert 51″ in an effective and reliable manner. Optionally, this connection may be reinforced by bonding.

Assembling the assembly 5″ to the cup 2″ is similar to assembling the assembly 5 to the cup 2.

Various arrangements and variants to the thermostatic elements 1, 1′ and 1″ described hereinabove, and to their method of manufacture, can be envisaged. As examples:
the piston 4, 4′, 4″ may be at least partly inserted into the passageway 53, 53′, 53″ of the assembly 5, 5′, 5″ before this assembly is placed in the collar 2C, 2C′, 2C″; and/or
the piston 4, 4′, 4″ may be furnished internally with an electric heating resistor designed to heat the wax 3, 3′, 3″ from the inside, the electricity supply conductors of this resistor extending from the end of the piston opposite to that immersed in the wax.

1. A thermostatic element comprising:
a heat-conductive cup containing a heat-expandable material,
a piston that can be moved along an axis (X-X) relative to the cup under the action of the heat-expandable material when this material expands,
a one-piece assembly comprising a rigid insert for guiding the piston relative to the cup, sunk into a flexible casing sealed against the heat-expandable material and interposed between the insert and, on the one hand, the piston and, on the other hand, the cup, wherein the insert includes an abutment for positioning the one-piece assembly relative to the cup, which abutment extends in protrusion toward the heat-expandable material from a substantially flat portion (51B; 51B′; 51B″) of the rest of the insert in a direction substantially parallel to the axis of movement of the piston, the space delimited, on the side of the insert facing the heat-expandable material, between the abutment and the flat portion of the insert being at least partly filled with a corresponding portion of filler of the casing, squashed with sealed pressure against a corresponding bearing portion of the cup.

2-17. (canceled)

18. The thermostatic element as claimed in claim 1, wherein the bearing portion of the cup is flat and extends in a manner substantially perpendicular to the axis of movement of the piston.

19. The thermostatic element as claimed in claim 1, wherein the abutment is suitable for centering the one-piece assembly relative to the cup, while interacting by having shapes which are complementary with an associated portion of the cup, in which or around which the abutment is placed.

20. The thermostatic element as claimed in claim 19, wherein the abutment is received in the associated portion of the cup with radial interposition of a portion of the casing.

21. The thermostatic element as claimed in claim 1, wherein the squashing of the portion of filler is of the order of 40%.

22. The thermostatic element as claimed in claim 1, wherein the bearing portion of the cup is furnished, on its face against which the portion of filler is squashed, with a groove filled with the portion of filler.

23. The thermostatic element as claimed in claim 1, wherein the abutment forms an annular edge substantially coaxial with the piston.

24. The thermostatic element as claimed in claim 1, wherein a portion of the cup and the abutment are swaged together.

25. The thermostatic element as claimed in claim 1, wherein the casing forms, on the side of the insert facing the heat-expandable material, a first sealing protrusion relative to the heat-expandable material pressed against the piston.

26. The thermostatic element as claimed in claim 1, wherein the casing forms, on the side of the insert opposite to the heat-expandable material, a second sealing protrusion relative to the outside of the cup, particularly relative to a fluid in which the thermostatic element is bathed, pressed against the piston.

27. The thermostatic element as claimed in claim 26, wherein the first protrusion and/or the second protrusion are furnished, on their surface suitable for being pressed against the piston, with at least one rib for reinforcing the seal.

28. The thermostatic element as claimed in claim 27, wherein the second protrusion is furnished, on its surface suitable for being pressed against the piston, with at least one rib for reinforcing the seal.

29. The thermostatic element as claimed in claim 1, wherein the casing is made of a material chosen from rubber, nitrile, hydrogenated nitrile or a mixture of these materials.

30. The thermostatic element as claimed in claim 1, wherein the insert delimits an opening for receiving and guiding the piston, whose wall is covered by a corresponding portion of the casing.

31. The thermostatic element as claimed in claim 1, wherein the insert is conformed essentially by stamping, machining, or drop-forging.

32. The thermostatic element as claimed in claim 1, wherein the casing forms a blind glove finger suitable for receiving the end portion of the piston facing the heat-expandable material.

33. The thermostatic element as claimed in claim 32, wherein the casing delimits a reserve of grease opening onto the piston.

34. A method for manufacturing a thermostatic element in which are provided:
a heat-conductive cup partly filled with a heat-expandable material,
a piston; and
a rigid insert for guiding the piston,
in which the piston is partly fitted inside the cup, so that this piston can be moved along an axis relative to the cup under the action of the heat-expandable material when this material expands,
in which the insert is sunk into a flexible casing sealed against the heat-expandable material and suitable for being interposed between the insert and, on the one hand, the piston and, on the other hand, the cup, the insert and the casing forming a one-piece assembly, and
in which the one-piece assembly is fitted into the cup so that a portion of the casing is interposed between the insert and the cup while another portion of the casing is interposed between the insert and the piston when the latter is assembled,
wherein, when the one-piece assembly is placed in the cup, this assembly is positioned relative to the cup by using an abutment of the insert, which extends in protrusion toward the heat-expandable material from a substantially flat portion of the rest of the insert in a direction substantially parallel to the axis of movement of the piston, the space delimited, on the side of the insert facing the heat-expandable material, between the abutment and the flat portion of the insert being at least partly filled with a corresponding portion of filler of the casing,
and wherein, after the one-piece assembly has been placed in the cup, this portion of filler is squashed axially with sealed pressure against a corresponding bearing portion of the cup, by swaging the abutment and the cup together.
